(19) United States
(12) Patent Application Publication
(10) Pub. No.: US 2015/0220488 A1
(43) Pub. Date: Aug. 6, 2015

(54) System and method for interferometrically tracking objects using a low-antenna-count antenna array

(71) Applicant: Liam M. Healy, Washington, DC (US)

(72) Inventor: Liam M. Healy, Washington, DC (US)

(73) Assignee: The Government of the US, as represented by the Secretary of the Navy, Washington, DC (US)

(21) Appl. No.: 14/615,238

(22) Filed: Feb. 5, 2015

Related U.S. Application Data
(60) Provisional application No. 61/936,068, filed on Feb. 5, 2014.

(51) Int. Cl. G06F 17/18; G01S 13/84

(52) U.S. Cl. CPC G06F 17/18; G01S 13/84

(57) ABSTRACT

A radio-frequency interferometry method for determining parameters of motion of a moving object from phase difference information from an antenna baseline formed of two antennas. At each of a plurality of observation events, compute a posterior probability density function from the phase differences from the baseline, separate the modes with a threshold value of probability density, and compute a probability of each mode. For each possible sequence of modes, determine a mode sequence probability as the product of the probabilities of each mode in that sequence, estimate a χ² goodness of fit function based on an assumed type of motion. Determine the net probability of each possible sequence of modes as the product of a relative probability derived from the χ² and the mode sequence probability. Alternately, two or more parallel or colinear baselines are used, and the posterior PDF is a combined PDF over each of the baselines.

### CROSS-REFERENCE TO RELATED APPLICATIONS

This Application is a non-provisional under 35 USC 119(e) of, and claims the benefit of, U.S. Provisional Application 61/936,068 filed on Feb. 5, 2014, the entire disclosure of which is incorporated herein in its entirety.

### BACKGROUND

1. Technical Field

This invention is in the field of radio frequency interferometry.

2. Related Technology

Radio frequency interferometry is an established technique for tracking moving objects. In this method, a radio frequency signal is emitted by the object and detected with a interferometer. In an alternative radio frequency interferometry method known as “skin tracking”, a transmitter emits a radio frequency signal, and that signal is reflected off of the metal parts of the object and detected by the interferometer.

These interferometers typically include several antennas. With short enough baselines, a unique solution for the location at the time of measurement can be found, but the noise inherent in any measurement has a large effect on the direction determination. With longer baselines, there are multiple possible solutions for the direction, but the noise has a smaller effect on the determined direction. Therefore, effective radio frequency interferometry systems can typically use up to a dozen or more antennas with different baseline lengths, providing a unique high accuracy solution. However, such a large array requires a considerable amount of antennas, electronics, cabling, as well as the space to install the hardware. In addition, in practice, even with large numbers of antennas, the direction can still be misidentified.

An example of a radio frequency interferometer used for direction-finding was the Air Force Space Surveillance System (formerly the Naval Space Surveillance System), otherwise known as the “space fence.” It was a multistatic radar whose transmitters operated around 217 MHz that started operation in the late 1950s and was shut down in 2013. In its last incarnation, there were two perpendicular axes, oriented northeast-southwest and northwest-southeast, and a total of ten to twelve antennas at each of six sites across the southern United States that each covered an area approximately 1200 feet by 1200 feet.

### BRIEF SUMMARY

A radio-frequency interferometry based method for determining parameters of motion of a moving object from phase difference information from at least one radio-frequency antenna baseline, the baseline including two antennas. The method includes at each of a plurality of observation events, computing a combined probability density function from the phase differences over the antenna baseline, applying a threshold value of probability density to separate the modes, and computing a probability of each individual separated mode; for each possible sequence of modes, determining a mode sequence probability as the product of the probabilities of each individual separated mode in that sequence; estimating a χ² goodness of fit function based on an assumed type of motion; and for each of the sequences of modes, determining the net probability of each possible sequence of modes as the product of a relative probability derived from the χ² and the mode sequence probability.

The method can determine parameters of motion of the moving object from phase difference information from at least two radio-frequency antenna baselines, each of the baselines including two antennas, each baseline having a length different than the other baselines, and each baseline being parallel with the other baselines.

### BRIEF DESCRIPTION OF DRAWING FIGURES

FIG. 1 illustrates an antenna system with an antenna baseline of length L extending between antenna A and antenna B.

FIG. 2 illustrates the concept of cycle ambiguity for a repeated cycle.

FIG. 3 illustrates a radio-frequency-interferometry system for tracking a moving object 300 with an array of only a few antennas.

FIG. 4A, 4B, and 4C show different configurations of antenna pairs.

FIG. 5 illustrates an exemplary method for tracking a moving object based on signals from only a few antenna elements.

FIG. 6A-6F illustrates probability density functions that result from possible observations of an object in a specific direction.

FIG. 7 shows credible region R in a posterior multimodal PDF.

FIG. 8A through 8D illustrate the effect of different thresholds on the modes of the probability density functions.

The plots in FIG. 9A-9F show the negative log probability weight value for the top six ranked results plotted for a simulation of the radio-frequency-interferometry method for tracking objects.

FIG. 10 illustrates some results from a simulation of linear motion with five simulated observations in a sequence. Additional details will be apparent from the following detailed description of some preferred embodiments.

### DETAILED DESCRIPTION

The systems and methods described herein can be used to receive signals from antennas that form interferometers and to track moving objects based on received signals at the antennas. The examples below describe tracking objects with linear motion, however, the objects can be various types of objects, can be in different environments, (e.g., on land, on the surface of or under water, through the air, or in space) and can have different models of motion (e.g., linear, orbital).

Direction finding with an interferometer has two components, the measurement of phase at two or more antennas, and the determination of direction from the difference of the phases. Consider first the problem of determining distance to the source from the received phase, understanding that the real interest is in the difference in the phases.

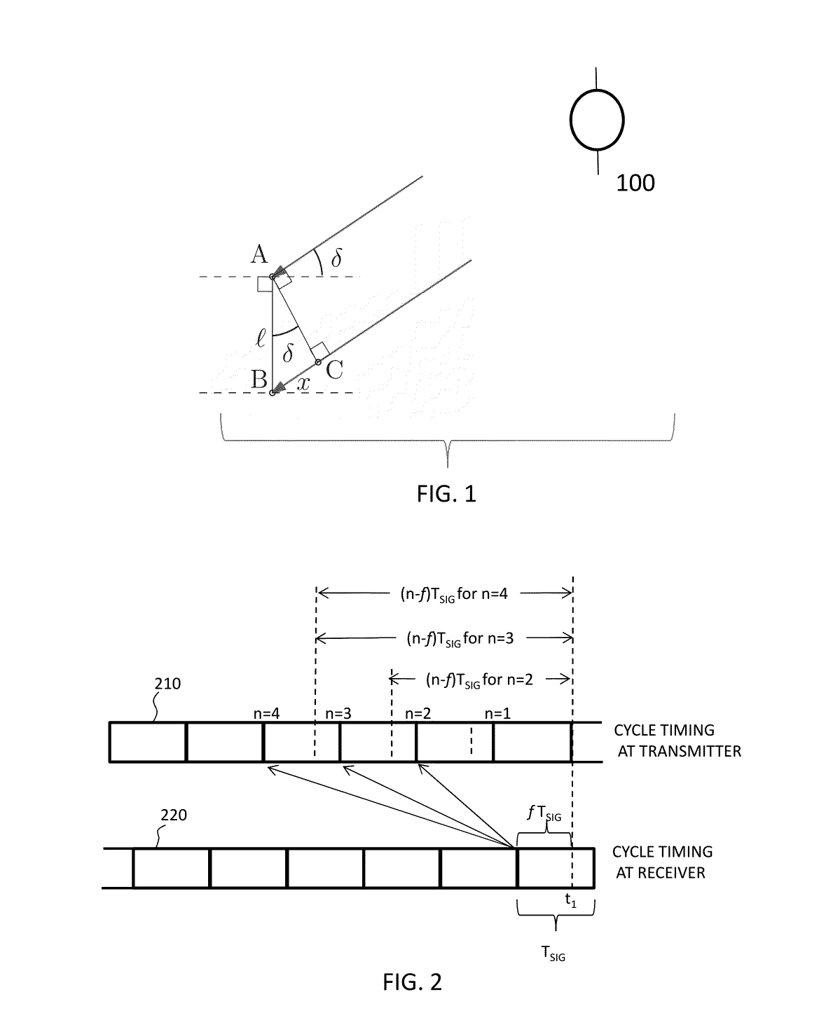

FIG. 1 illustrates an antenna system with an antenna baseline of length L extending between antenna A and antenna B.

The relative signal path length will identify the direction. The ranges from the two antennas are compared to give the pathlength difference x, which can be negative. The direction can be inferred with the equation

sin δ=x/L (1)

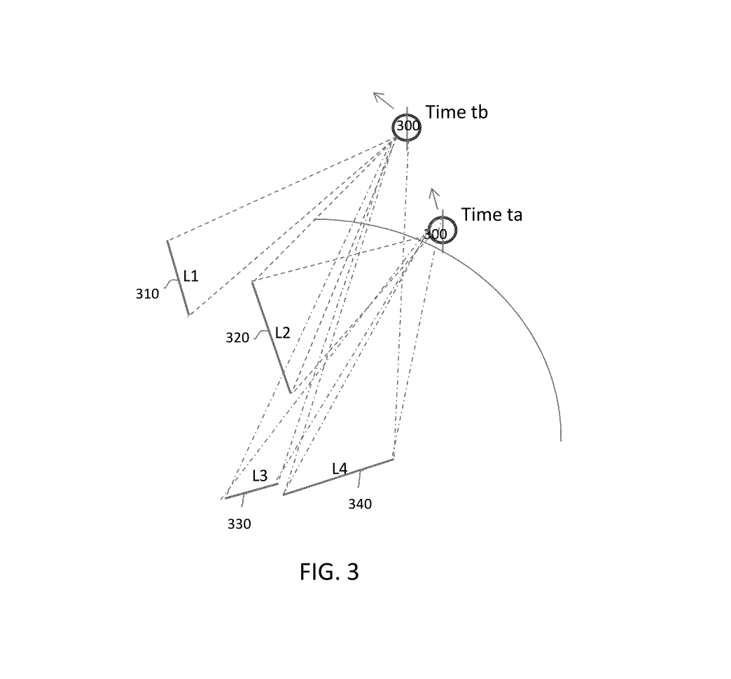

Suppose the signal being detected has a period T_{sig}. FIG. 2 shows the timing of repeated signal at the source (transmitter) 210 and repeated signals 220 at the receiver. In this figure, t₁ is the time at which a cycle starts on the transmitter, and f is the fraction of the signal period T_{sig} at t₁ after the cycle on the receiver, indicated by the solid line. This repeated code gives rise to a cycle ambiguity, meaning that with the signals received at antennas A and B alone, one cannot distinguish a given phase on one cycle from the same phase on another. As shown in FIG. 2, at a transmit cycle start time t₁, the received signal is determined to be a fraction f through the cycle, 0≦f<1. Although a receive time is known, the transmit time of the signal could be any number of different times, because the number of cycles is not known. Thus, the transmit time of the end of the received cycle is ambiguous, represented by an unknown integer n and a corresponding time nT_{sig}. Therefore, the flight time of the signal is proportional to the distance ρ traveled according to (n−f)T_{sig}=ρ/c, which can be rewritten as

ρ=cT_{sig}(n−f). (2)

Here n is an unknown integer representing the cycle ambiguity, and 0≦f<1 is the fractional phase of a complete cycle that can be measured. Any integer value of n that results in a value of s that is greater than or equal to −1 and less than or equal to 1 is a potentially valid solution.

Signals from a moving object 100 are received at the two antennas A and B. For signal having a period T_{sig}, the direction cosine s is defined as s=sin δ and is related to the phase difference of the signal received at the two antennas n−f as follows:

$$s \frac{L}{{cT}_{sig}} = n - f \qquad ( 3 )$$

with c being the speed of the signal.

One approach to determining the value of n with an interferometric radio frequency detector is to measure the signal with an array of many antennas, and match the results from multiple baselines to isolate the value of n with both low ambiguity and high in-mode precision. Motion estimation using interferometric direction finding can compute the direction at each observation deterministically and then use those results in a least squares estimation. Given an antenna array with a sufficiently large number of antenna elements and observation errors sufficiently small, the solutions for each baseline will align for only one value of s, which is taken as the solution. For each baseline L in equation (3), the possible directions s can be computed for all integers n. The answer is the value of s that has a solution for some integer n for each baseline.

A better approach to determining the correct value of n (e.g., determining the correct “mode”), and thus, the direction cosine s and/or other motion parameters, is to use a very small number of antennas and a novel computational approach that uses statistical calculation such as a least squares approach, separates the modes, then generates all combinations of modes. Each combination of modes is determined, and the combinations are then ranked in terms of likelihood based on both goodness of fit and mode probability factors. This approach can provide high quality results with very small arrays, and when applied to systems with large antenna arrays, can provide even more accurate results.

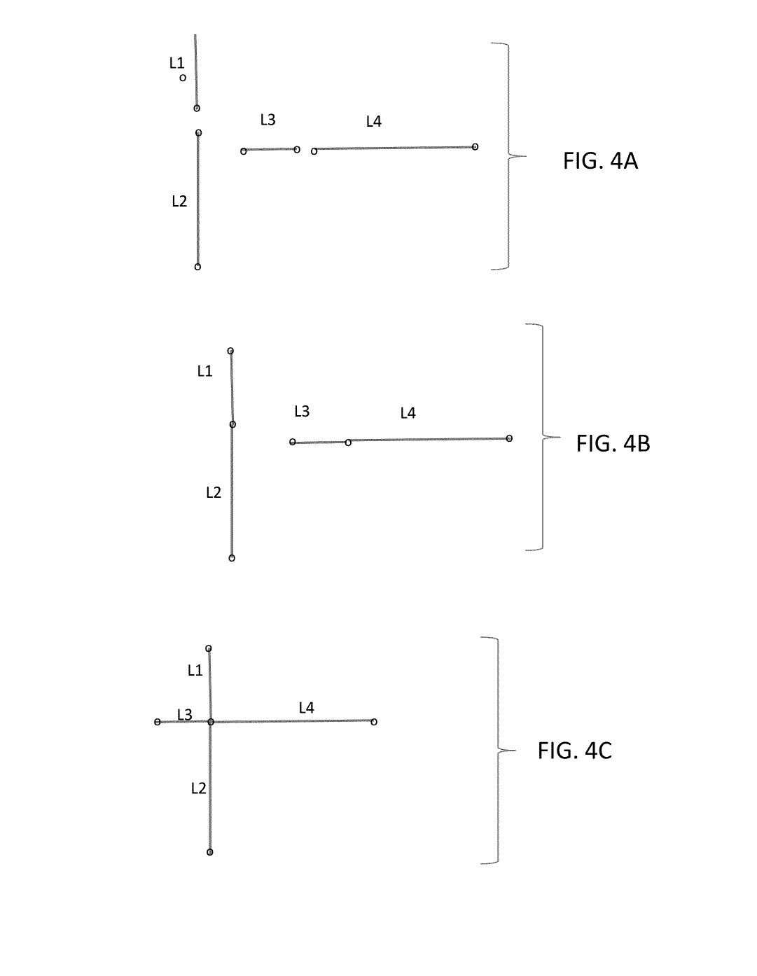

FIG. 3 illustrates a system for tracking a moving object 300 with a small array of antennas. Here, the moving object is a satellite in orbit, but it could be any of various other moving objects, such as, for example, vehicles, aircraft, ships. In this figure, a satellite moves a distance along a path from a time t₁ to a later time t₂. The antennas of at least two antenna baselines 310 and 320 aligned along the same direction (e.g., parallel or colinear) receive signals from the satellite. At least two antenna baselines 330 and 340 are perpendicular to the first two antenna baselines.

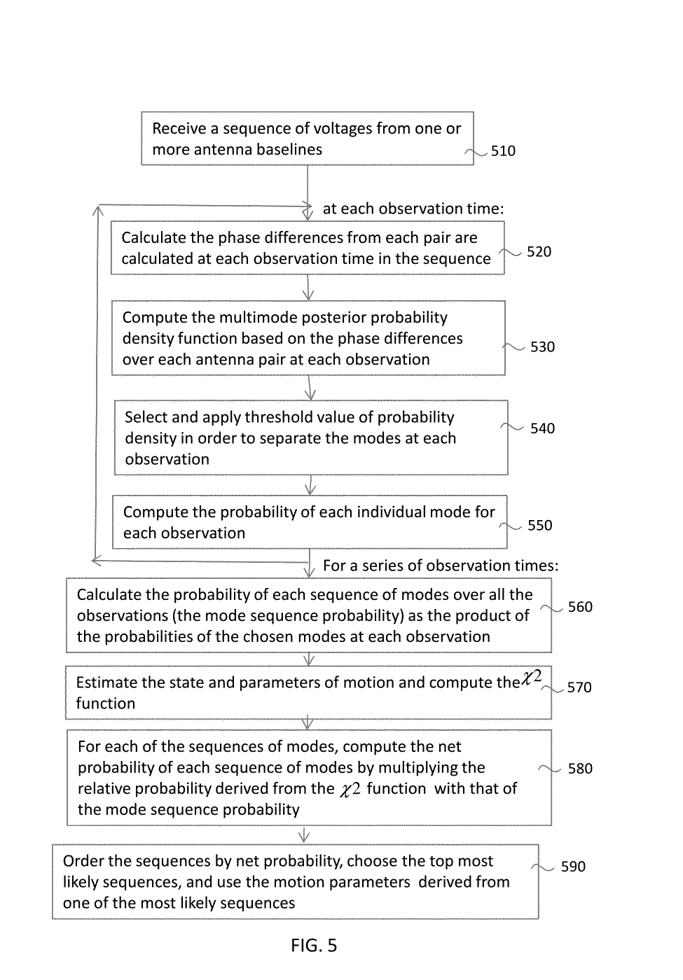

For now, only one pair of antenna baselines will be considered. It is preferred that the baselines be of different lengths that are not commensurable (in other words, the lengths should not be exactly divisible by the same unit an integral number of times). The aligned antenna baselines can be formed of two parallel pairs of antennas, such as shown in FIG. 3 or in FIG. 4A, with parallel antenna pair L₁ and L₂ and another parallel antenna pair L₃ and L₄. FIG. 4B and 4C show two pairs formed of three colinear antennas. In the FIG. 4B and 4C configurations, the same signals are received by the antenna common to both antenna pairs, so the simplification based on timing independence of antennas discussed in later paragraphs may not apply.

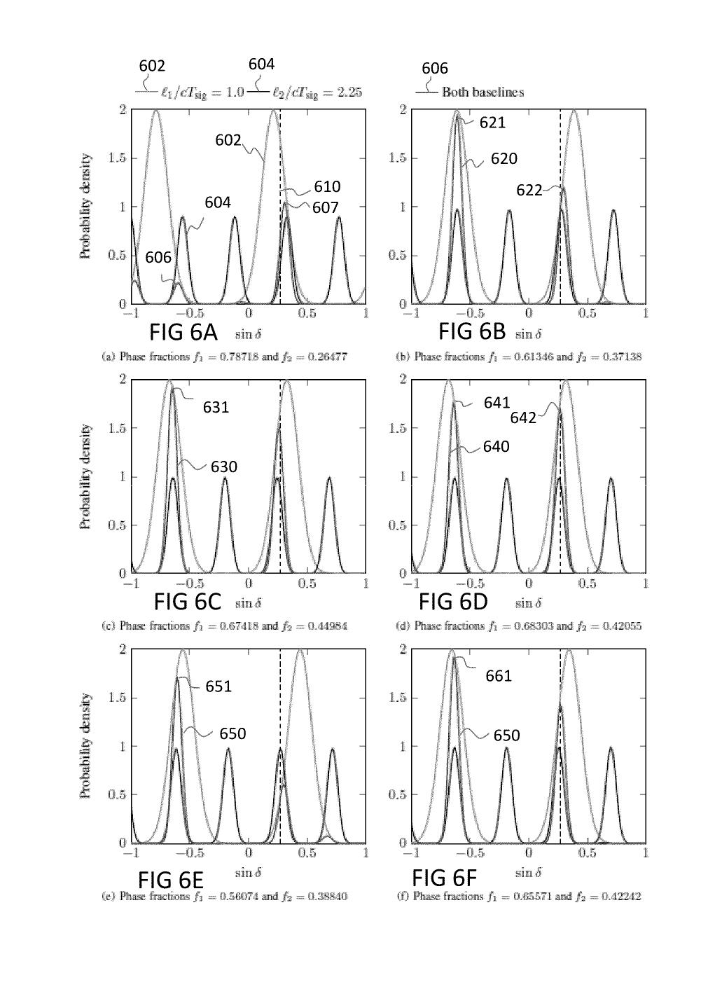

FIG. 5 illustrates an exemplary method for tracking (e.g., determining the direction of) a moving object based on signals from only a few antenna elements.

At 510, a sequence of radio frequency signals is received from at least one antenna baseline. The phase differences are calculated at each time in the sequence, at 520. The multimode posterior probability density function is computed based on the phase differences from the baseline (or baselines if there are more than one baseline), 530, at each observation. A threshold value of probability density is applied in order to separate the modes at each observation, 540. Next, the probability of each individual mode is computed for each observation, 550. The probability of each sequence of modes over all the observations (the mode sequence probability) is found by multiplying the probabilities of the chosen modes at each observation, 560. The state and parameters of motion are estimated and the χ² function is computed, 570. For each of the sequences of modes, the net probability of each sequence of modes is computed 580 by multiplying the relative probability derived from the χ² with that of the mode sequence probability. The sequences are ordered by relative probability, 590. The top combinations are selected, and the parameter estimate derived from one of the top mode sequence combinations can be used.

The result is a set of values at different observation times giving the relative probability of that set, as well as the mean and standard deviation estimating the parameters of the motion model.

Turn now to the step 530 of computing the probability density function based on the phase differences.

An interferometer with few baselines will produce a strongly multimodal probability density function.

The probability density function of a phase pair (n, f) given a direction cosine s for one antenna baseline (e.g., two antennas separated by baseline L) is

$$p ( n , f \vert s ) = \frac{{T}_{sig}}{{σ}_{t} \sqrt{2 π}} exp [ - \frac{{( n - f - sL / {cT}_{sig} )}^{2}}{2 {( {σ}_{t} / {T}_{sig} )}^{2}} ] \qquad ( 4 )$$

where p(n, f|s) is the probability density of the values of the mode n with phase difference f given values of s, and σₜ is a fixed standard deviation. This expression for p(n, f|s) is the PDF in f, assumes a Gaussian distribution of measured values of the time of arrival of the signal centered on the true time with a standard deviation σ.

Consider next a system with two antenna baselines that are parallel or colinear, one of the antenna pairs having a baseline L₁ and the other having a baseline of L₂. The joint PDF is the product of their univariate PDFs of equation (4), and can be written as:

$$\begin{matrix}p ( {n}_{1} , {f}_{1} , {n}_{1} , {f}_{2} \vert s ) = p ( {n}_{1} , {f}_{1} \vert s ) p ( {n}_{2} , {f}_{2} \vert s ) \\ = \frac{{T}_{sig}^{2}}{{σ}_{1} {σ}_{2} \sqrt{2 π}} exp [ - \frac{{( {n}_{1} - {f}_{1} - {sL}_{1} / {cT}_{sig} )}^{2}}{2 {( {σ}_{1} / {T}_{sig} )}^{2}} ] \\ exp [ - \frac{{( {n}_{2} - {f}_{2} - {sL}_{2} / {cT}_{sig} )}^{2}}{2 {( {σ}_{2} / {T}_{sig} )}^{2}} ]\end{matrix} \qquad ( 5 )$$

for an observation k, where k is an integer index of the observation events. The summations are over all possible values of the modes n₁ and n₂.

Here, s is the direction cosine of the signal from the object, T_{sig} is the period of the signal, c is the velocity of the signal (which can be assumed to be the speed of light in a vacuum), n₁ represents the modes associated with the first baseline L₁, n₂ represents the modes associated with the second baseline L₂, f₁ is the fraction of the signal through the cycle T_{sig} for the antenna baseline L₁, f₂ is the fraction of the signal through the cycle T_{sig} for the antenna baseline L₂. The baselines L₁ and L₂ are parallel or colinear.

The posterior PDF for the two-baseline case is

$$p ( s \vert {f}_{1} , {f}_{2} ) = \frac{\begin{matrix}{\sum }_{{n}_{1}} {\sum }_{{n}_{2}} exp [ - \frac{{( {n}_{1} - {f}_{1} - {sL}_{1} / {cT}_{sig} )}^{2}}{2 {( {σ}_{1} / {T}_{sig} )}^{2}} ] \\ exp [ - \frac{{( {n}_{2} - {f}_{2} - {sL}_{2} / {cT}_{sig} )}^{2}}{2 {( {σ}_{2} / {T}_{sig} )}^{2}} ]\end{matrix}}{\begin{matrix}\int p ( {s}^{′} ) {\sum }_{{n}_{1}} {\sum }_{{n}_{2}} exp [ - \frac{{( {n}_{1} - {f}_{1} - {s}^{′} {L}_{1} / {cT}_{sig} )}^{2}}{2 {( {σ}_{1} / {T}_{sig} )}^{2}} ] \\ exp [ - \frac{{( {n}_{2} - {f}_{2} - {s}^{′} {L}_{2} / {cT}_{sig} )}^{2}}{2 {( {σ}_{2} / {T}_{sig} )}^{2}} ] d {s}^{′}\end{matrix}} \qquad ( 6 )$$

for an observation k for an observation k, where k is an integer index of the observation events. The summations are over all possible values of the modes n₁ and n₂.

Given observed values of f₁ and f₂, p(s|f₁, f₂) is the probability density for different values of the direction s.

Equations (5) and (6) assume independence, which is a reasonable assumption if the timing is independent, because timing is believed to be the major source of the random variation in this model. Timing independence occurs of the two baselines are formed of two pairs of antennas with independent timing and detection electronics. However, if the array of two baselines is formed of only three antennas in a line, with one of the antennas being a component of each of the two baselines, then the common electronics used for timing might make the two PDFs dependent. In this case, equations (5) and (6) above might not accurately represent the true PDFs because they do not consider the non-independence of the timing.

Thus, the step 530 of computing the multimodal posterior probability density function from observations (phase differences) for two parallel baselines with independent timing can be accomplished according to equation (6).

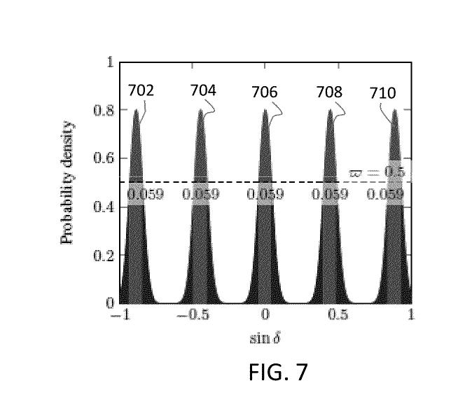

FIG. 6A-6F illustrates possible probability density functions that could result from various values of baseline/wavelength ratio and for different phase fractions, at a particular observation time. In this example, the object has an actual direction cosine s=0.27 and two antenna with different baselines—one antenna having a baseline/wavelength ratio L/(cT_{sig}) of 1.0, and a second antenna with a baseline/wavelength ratio L/(cT_{sig}) of 2.25.

FIG. 6A shows the probability densities for phase fractions f₁=0.78718 and f₂=0.26477, plotted against sin δ. Curve 602 is the single-baseline PDF for a baseline/wavelength ratio of 1.0. Curve 604 is the single-baseline PDF for a baseline/wavelength ratio of 2.25. A combined probability density function according to equation (8) is represented by curve 606. The actual direction cosine s=0.27 is shown by the dashed line 610. Note that in this figure, the peak 607 of the combined PDF curve 606 aligns fairly well with the actual direction s=0.27. However, FIG. 6B-6F show that at many other phase fractions, the combined PDF alone does not unambiguously identify the correct direction s. FIG. 6B, for example, shows the combined PDF curve 620 having the strongest peak 621 at a value of sin δ=0.27, and the next highest peak 622 at approximately sin δ=0.3, which is much closer to the actual s=0.27 direction. Similarly, in FIG. 6C, 6E, and 6F, the combined PDF curves 630, 650, and 660 have higher values at peaks 631, 651, and 661 at directions that do not correspond to the correct s=0.27 value. FIG. 6D shows the combined PDF curve 640 with peaks 641 and 642 that are approximately equal. However, in each figure, the combined PDF does identify several modes that are possible solutions to the equation (3) above (e.g., at all the peaks of the combined PDF curves).

Therefore, it is useful to separate the modes by applying a threshold value so that the probabilities of different modes occurring in sequence can be combined in later steps.

### Separation of Modes by Applying a Threshold Value of the PDF

The modes are separated by applying a threshold value to the multimodal PDF, as shown at step 540 of FIG. 5. Each mode is identified with an interval in direction cosine space (“s” space), meaning that within that interval, all values of the direction cosine are associated with a density that exceeds the threshold, while outside the interval, the density is below the threshold.

Before describing how the threshold value is selected, a few comments are provided related to how to best represent a multimodal probability distribution.

When computing statistical numbers, is useful to be able to summarize the results in a reasonably compact form. For a normal distribution PDF, the distribution can compactly described with the value of the parameter “±”the standard deviation, or three times the standard deviation, or some similar convention.

For multimodal distributions, a different description is needed. Bayesian inference has a concept called credible interval, which is an interval in the domain of the posterior that expresses a certain probability the result lies in that interval; in other words, the integral of the posterior PDF over that interval is equal to the specified credible level. For example, in an experiment that determines the uncertainty distribution of parameter, if the probability that lies between 35 and 45 is 0.95, then [35, 45] is a 95% credible interval for t. In multiple dimensions, the credible region expressing a certain probability level can be any shape.

To determine the credible region that expresses a certain specified probability, E. T. Jaynes' notion of shortest interval with a specified amount of probability can be adapted to multimodal and multidimensional problems, in which we seek the smallest region (instead of shortest interval) over whose integral the PDF yields the desired probability. See, for background, E. T. Jaynes, “Confidence intervals vs. Bayesian intervals”, in W. L. Harper and C. A. Hooker, eds., Foundations of Probability Theory, Statistical Inference, and Statistical Theories of Science, pages 175 et. seq., 1976.

A threshold of the posterior PDF, ω, is initially selected. The set of points in its domain (in this case, s) is found for which the p(s|f)≧ω, where p(s|f)≧ω is the probability of a direction cosine s given a phase fraction f. This set of points is called the credible region R.

It is preferable to start with a high enough level El that the credible region is empty. As the level El is reduced, the region grows in measure (e.g., length, area, volume, depending on the dimensions), and the corresponding integral grows until it reaches the desired probability.

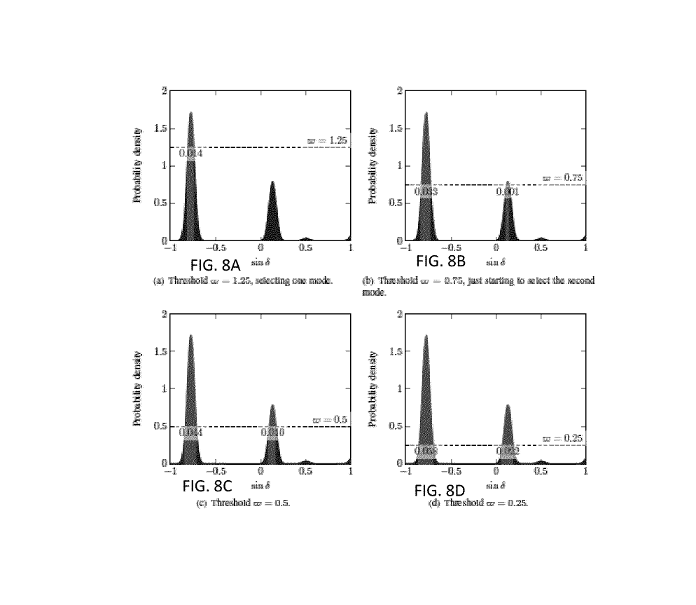

A given region R can be described as the union of some number of connected regions, called “segments”, which each correspond to one mode. FIG. 7 shows credible region R in a posterior multimodal PDF for one baseline. The threshold value, ω, is 0.5, shown by dashed line. The region R is discontiguous and is composed of five segments 702, 704, 706, 708, and 710, with R being the union of the segments. The probability resulting from integration over all values of s∈R is the credible level, and in this example, is 5×0.059=0.295.

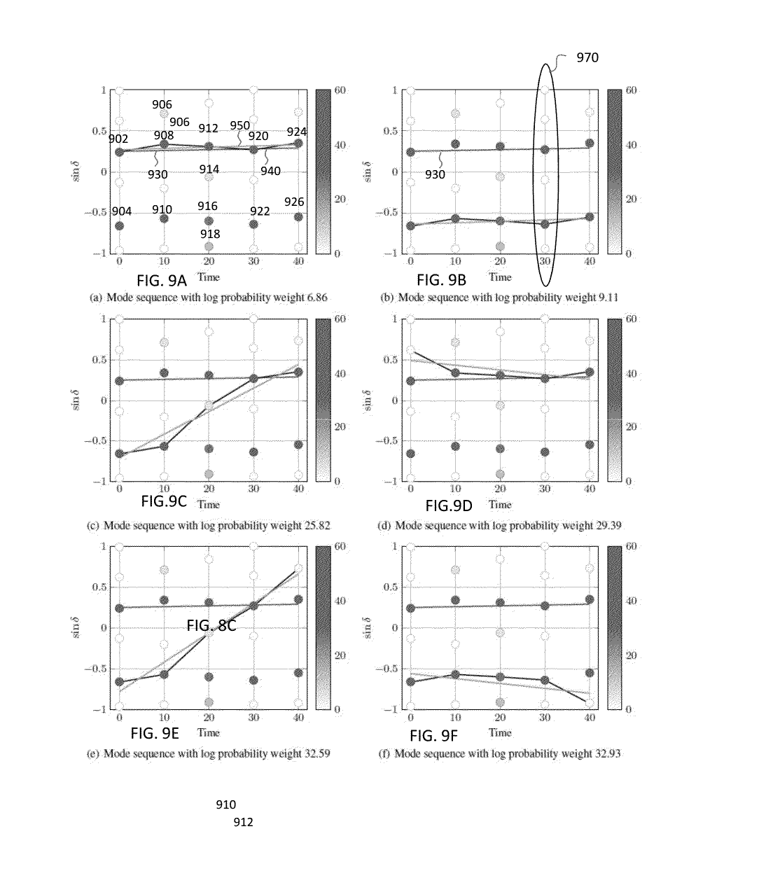

FIG. 8A through 8D illustrate the multimodal distribution of the probability density for two baselines.

For each of the modes in either a single baseline or a multiple baseline antenna configuration, a mean and standard deviation or other summary statistics can be determined. The method described herein can be extended to multiple dimensions, in which the region is not the union of intervals on the real line, but the union of connected higher-dimensional segments. For this example, however, only one dimension, s, is considered.

Obtaining a particular credible level R is governed by the setting of the threshold ω and is done iteratively. By setting a particular threshold, modes that fall below the threshold are effectively too low a probability to be considered further. If the threshold value is set too high, modes may be missed that, while unlikely, still may happen and may even produce a more in-mode precise result, even when not actually in one of these minor modes. In other words, the missed mode may have a higher integrated probability (“probability mass”) than another mode that is caught if the missed mode is broad enough. If that is the case, that mode, or a sequence involving that mode, will be determined to have probability zero. If the discarded mode were the actual mode, then the correct trajectory will be missed completely because it has been assigned a zero probability, regardless of how closely the other directions in the sequence match the actual trajectory. On the other hand, if the threshold value is set too low, modes may mix with no clear separation. If the threshold is set too low, but not so low that the modes mix, it may create too many possibilities. Doubling the number of modes at each of five observations means that the number of combinations to be analyzed increases 32-fold, and if there are more observations the number of combinations is much greater.

An effective way to find a good threshold for a particular antenna configuration (e.g., baseline lengths, expected wavelength of signals, distribution of errors in the measurement) is to simulate motion and sample data with a Monte Carlo method, adjusting the threshold until the known correct directions occur with the highest probability weight, as discussed in the paragraphs below. This allows the threshold to be set for a given antenna baseline configuration, and adjusted later as appropriate.

FIG. 8A through 8D illustrate the multimodal distribution of the probability density for two parallel or colinear baselines, at an observation event k, based on simulated data from a satellite orbit estimation algorithm discussed in later paragraphs. In this example, the baseline to wavelength ratios are 1.0 and 2.25, and the phase fractions are f₁=0.25 and f₂=0.25.

These figures illustrate the effect of different threshold ω values (1.25, 0.75, 0.5, and 0.25) on the credible level. By inspection, is clear that the mode at s=−0.77 is more probable than the other modes at any threshold. As the value of the threshold ω is changes, the number and probability of the consequent credible segments changes. A sufficiently high credible level (e.g., ω=1.25) selects only one mode at s=−0.77, as seen in FIG. 8A, with the mode having a probability of 0.014. In FIG. 8B, the threshold value of ω=0.75 is just starting to select a second mode, and the probabilities for each mode are 0.033 (s=−0.77) and 0.001 (s≈0.2). In FIG. 8C, the threshold of ω=0.5 selects two modes, and the probabilities for each mode are 0.044 (s=−0.77) and 0.01 (s≈0.2). In FIG. 8D, the even lower threshold of ω=0.25 selects two modes, and the probabilities for each mode are 0.058 (s=31 0.77) and 0.022 (s≈0.2). The sum of the probability for each figure is the credible level. Note that for lower credible level, R is no longer connected, and the other modes have lower probability.

The step of computing the probability of each individual mode for each observation 550 accomplished by computing the area under the multimodal posterior PDF curve for that mode between values of sin δ at which the curve intersects the selected threshold.

### Probability Weight and Ranking of Results

Next, we consider the step 560 of computing the mode sequence probability of each sequence of modes over all the observations.

Each observation of the object is considered as part of a sequence while the object is moving, rather than stationary. If the object is known to have a particular type of motion (e.g., a satellite can have an orbital motion, other objects may have linear motion), the type of motion provides valuable information that can reduce uncertainty, even if the parameters of the motion (e.g., initial position and velocity) are not known.

To use the motion model statistically, we look at all combinations of the modes. The modes identified at each observations are combined in different combinations into sequences, which are then ranked by the relative probability. The number of possible sequences is the product of the number of modes at each observation multiplied by the number of observations in the sequence. The relative probability of a sequence is derived from two sources: the product of the probabilities of the modes in the sequence, and a probability derived from the goodness of fit of the model parameters.

If the combinations of sequences were to be analyzed on the relative probability of their modes alone (each sequence has a “mode sequence probability”, the product of the probabilities of the modes in the sequence), then the correct sequence may be missed because it may not have the largest probability. This is because the modes may have very similar probability masses, or because the correct mode may not have the highest probability mass of all the modes. Thus, many combinations of modes over the observations may have product probabilities that exceed that of the actual sequence of modes, and so the ranking of the correct sequence may be quite low.

The second source of probability is the goodness of fit. For example, from a least squares estimation we may compute the residuals, and the sum square of these residuals, or χ²value, is computed as

$${χ}^{2} = {\sum }_{k} {( \frac{{f}_{k}^{obs} - {f}_{k}^{pred}}{{σ}_{f}} )}^{2} \qquad ( 7 )$$

where fₖ^{obs} is the observed value of the fractional phase difference at observation k, fₖ^{pred} is the predicted value based on the estimated (fit) parameters, and σ_{f} is the standard deviation of the observations, assumed the same for each observation. Additional information about calculating the χ² is provided below.

In one embodiment, the probability density associated with the χ² value can be computed with an exponential function. Then, the combined probability weight that takes into account both the goodness of fit χ² factor and the mode sequence probability (product of individual mode probabilities) for a particular sequence of modes can be calculated according to

$$p ( \{ {s}_{k} \} \vert \{ {f}_{k} \} , \{ {n}_{k} \} , {σ}_{f} ) ∝ exp ( - \frac{{χ}^{2}}{2} ) \prod {p}_{k} \qquad ( 8 )$$

where the braces { } indicate the set of values over all observations k. For a two baseline example, pₖ is the posterior probability density function p(s|f₁,f₂) from equation (6) above at an observation event k. In other words, pₖ is equal to p(s|f₁_{ₖ}, f₂_{ₖ}).

For each combination of modes, the product of the modal probabilities is multiplied by the χ² value computed after the fit is computed. This produces a “net probability weight” or “probability weight” for each sequence of modes that can be used to rank the sequences with significantly better results than that of the modal probabilities alone. This is called a probability weight rather than a probability because it does not sum or integrate to one over all possible outcomes, but rather provides a relative strength of belief in that sequence of directions. In equation (8), p({sₖ}|{fₖ},{nₖ},σ_{f}) is the net probability weight of a sequence of modes considering both the χ² goodness of fit factor and the mode sequence probability.

A challenge in computing the χ² function is the multimodal distribution; in the fractional phase difference space of the observations, there are several possible direction cosines s that give the same result. However, in this context, it means that when comparing different modes, the false modes may look as good as the true mode. Thus, for an entire sequence, the weighted rank of the correct combination of modes can be quite low. Where the χ² requires the observation residual, that is, the difference in the observed quantity and the predicted, in our case this should include not only the fractional part f but the integer n, in other words, the complete phase difference n−f counting whole cycles. Of course, the integer part of the phase difference n is unavailable, so we use the left side of equation (3) instead of the right.

In the parameter space of direction cosines, there is no cycle ambiguity. Thus, if we compute the residuals in this space, the probability weight of sequences involving false modes will generally be lower than the true sequence. That is, compute sum square residuals, but of direction cosines,

$${χ}^{2} = {\sum }_{k} {( \frac{{s}_{k} - {s}_{k}^{pred}}{{σ}_{s}} )}^{2} , \qquad ( 9 )$$

where sₖ is the direction cosine solved at an observation, and sₖ^{pred} is the direction cosine predicted from the least squares fit. This function will unambiguously be smallest when the solved motion most closely follows the model motion. The direction cosine sₖ is not directly observed. Instead, it is computed from each observation fₖ^{obs} by rearranging (3) to solve for s,

$${s}_{k} = \frac{n - {f}_{k}^{obs}}{L / {cT}_{sig}} . \qquad ( 10 )$$

With n unknown, this can be solved by iterating through the possible integer values of n to minimize the absolute difference between sₖ and the s value of the mode as determined by the PDF maximum over the interval. The corresponding value of sₖis used in (13). The χ² is computed for each baseline, so

$${χ}^{2} = {\sum }_{k} [ {( \frac{{s}_{k 1} - {s}_{k}^{pred}}{{σ}_{s}} )}^{2} + {( \frac{{s}_{k 2} - {s}_{k}^{pred}}{{σ}_{s}} )}^{2} ] . \qquad ( 11 )$$

The relationship of the observation standard deviations σⱼ to the direction cosine standard deviations σₛ is straightforward,

$${σ}_{s} = \frac{{σ}_{f}}{L / {cT}_{sig}} . \qquad ( 12 )$$

The direction cosine standard deviation σₛ is computed separately for each antenna pair, even if the timing uncertainty is the same. The χ² value is then

$${χ}^{2} = {\sum }_{k} [ \frac{{L}_{1}}{{cT}_{sig}} {( \frac{{s}_{k 1} - {s}_{k}^{pred}}{{σ}_{f 1}} )}^{2} + \frac{{L}_{2}}{{cT}_{sig}} {( \frac{{s}_{k 2} - {s}_{k}^{pred}}{{σ}_{f 2}} )}^{2} ] . \qquad ( 13 )$$

with the predicted direction cosine at an observation time tₖ given by the motion model. If σ_{f1}=σ_{f2} the denominators can be pulled outside of the sum. This transformation into s space eliminates ambiguities that could remain if a traditional χ² technique were used. Note that equation (13) is specific to two baselines (k=2). Equation (13) provides the value of χ² in s space that is input to equation (8) to determine the net probability weight of a sequence of modes.

The method can be generalized and applied to additional baselines by summing over all the baselines k>2.

This system and method described above uses a novel approach, identified here as a “Multiple Mode Combinatorial Hypothesis Least Squares”. The multimodal posterior PDFs are calculated for each observation event (each “time”), and we select threshold density values from the multimodal posterior PDF at each observation event, which separates the modes. Each mode is given a relative probability. The product of those relative probabilities for a particular sequence of modes is the mode sequence probability. Once a least squares estimation is computed, the χ² goodness of fit can be used to compute a probability weight for the sequence according to equation (8), and then each of the different combinations of modes are ranked against one another.

As one example, if there are five observation events, the first, third, and fourth having five modes each, the second having four, and the last one having three, then the total number of combinations to analyze is 5×4×5×5×3=1500. In each of the cases, the relative probability is computed from the integral of the PDF over the interval. These individual mode probabilities are then multiplied over the combination of modes chosen, and the product multiplied by the χ² probability of the least squares fit for that combination. This produces an output that represents a PDF of the estimated parameters, with a mean, a standard deviation, and a relative probability for each combination (e.g., in this example, 1500 combinations).

This method and system provides a fundamentally different presentation of data than has been previously used. It also provides a representation of the PDF that is more useful in possible follow-on analysis, e.g., for doing orbit determination.

### EXAMPLE

In one example, the model motion is that of an object moving at constant speed in one dimension in s=sin δ space; linear motion as a function of time,

sₖ^{pred}=s^{pred}(tₖ)=s₀+\dot{s}(tₖ−t₀). (9)

where s₀ and \dot{s} are the intercept and slope from the linear least squares fit. While typically orbital motion is nonlinear over long time periods, for short arcs linear motion may work well, so is sufficient for evaluating simulation results.

Sample observation data from a two-baseline interferometer was generated at each time step from the direction s computed according to the model motion using the PDF p(f₁, f₂|sₖ). This is generated with an acceptance-rejection Monte Carlo method. Modes sequences are determined as discussed above based on this observation data, and a list of mode sequences with estimated parameters produced. This list is ranked by posterior probability weight, with the posterior probability weight providing a gauge of the likelihood of that combination of modes.

In this example, s₀=0.25, \dot{s}₀=0.001, and two baselines with L₁/cT_{sig}=1.0 and L₂/cT_{sig}=2.25, with five simulated observations in a sequence. Sample observations with measurement noise σ_{f}=0.1, or 36 degrees, a large number given current electronics technology.

The plots in FIG. 9A-9F show the negative log probability weight value for the top six ranked results plotted for a simulation. Each of the figures represents a possible sequence of modes that has been determined based on the steps above. Five observation events at five different times that are 10 units apart are represented along the x axis. The y axis is the directional cosine s=sin δ.

At each time, each of the modes that survived the threshold application is shown as a dot whose relative probability for that observation is represented by the scale along the right of the figure. In each figure, at time t=0 in FIG. 9A, there are two modes 902 and 904. Here, the modes seem to have about equal probability. At the next time (t=10), three modes 906, 908, and 910 survived the threshold application, with mode 906 having the lowest probability and 910 the highest probability. At the third time (t=20), four modes 912, 914, 916, 918 are shown, with mode 912 having the highest probability and 914 having the lowest probability. Two modes 920 and 922 are shown at time t=30 with mode 920 having a slightly higher probability than mode 922. Two modes 924 and 926 are shown at time t=40, with 926 having a slightly higher probability. In each figure, the line 930 represents the true motion of the object.

FIG. 9A shows one possible combination of modes (a mode sequence) with modes 902, 908, 912, 920, 924 and with a line 940 joining each mode in this combination. The line 950 represents the estimated motion based on the possible sequence of modes 902, 908, 912, 920, 924.

The probability weight of this sequence of modes is determined according to equation (8), and the log probability weight is determined to be 6.86. Note that the line 950 representing the estimated motion (the best fit to the mode sequence) is very close to the true motion shown by the solid line 930.

FIG. 9B illustrates another possible sequence of the modes, 904, 910, 916, 922, 926. Note that the log probability weight is determined to be 9.11, indicating that this sequence of modes is less likely than the sequence of FIG. 9A.

FIG. 9C illustrates yet another possible sequence of the modes, with the mode sequence line through 904, 910 914, 920, and 924. The log probability weight is determined to be 25.82, indicating that this sequence is much less likely than either of the FIG. 9A or FIG. 9B mode sequences. FIGS. 9D, 9E, and 9F illustrate other mode sequences, determined to be very unlikely.

Note that at each time, the identified modes correspond to a multimode posterior probability density function. For example, the modes in 9B at time t=30 circled at 970 might have a probability density function of FIG. 8D, for example—with two modes above the threshold.

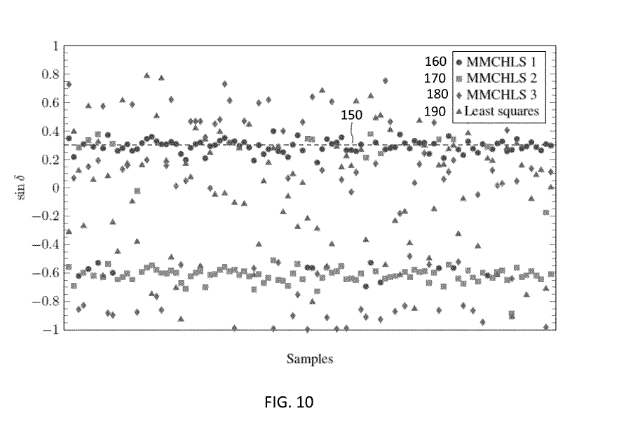

FIG. 10 illustrates some results from a simulation of linear motion with s₀=0.25, \dot{s}=0.001, and two baselines with L₁/cT_{sig}=1.0 and L₂/cT_{sig}=2.25, with five simulated observations in a sequence. Again, sample observations are generated with measurement noise σ_{f}=0.1, or 36 degrees.

Prior to doing a large sample, we set the density threshold to separate the modes, as discussed previously. Starting with a threshold of ω=0.5 and looking at a sample size of 20, the threshold was reduced until the rank of the correct sequence increases. As the threshold was decreased further, the weight of the correct sequence began to decrease. The correct threshold to chose was then taken roughly as the midpoint of those values (approximately 10⁻⁴for this example). For smaller measurement noise σ_{f}<0.1, this threshold level produces equal or better results compared to σ_{f}=0.1. For a larger measurement noise σ_{f}>0.1, the threshold level should be increased to identify the correct mode sequence. At σ_{f}=0.2, a density threshold value ω of about 0.02 finds the correct sequence of modes in roughly 80% of the samples, but the rank of those samples found is not particularly high.

For 100 sequence samples, the correct sequence of modes was the highest ranked 88 times, and the second highest rank the rest. In all the cases, the number of combinations considered is in the thousands, and as high as 5400. In this antenna array, there are two major modes, and two or three minor ones, as seen for example in FIG. 9A-9F. In those twelve cases in which the correct sequence was ranked second, the first ranked sequence was the one that passed through all of the other major modes. In the cases where the correct sequence of modes was highest ranked, the second ranked sequence was the one that passed through other major mode at each observation, as illustrated in FIG. 9B.

The sample size was enlarged to 1000, and the proportion indicated, 88% with the correct sequence highest rank and 12% second highest rank, held. See, for example, FIG. 10, which illustrates how well different highly ranked sequences 160, 170, and 180 match the correct answer (the dashed line 150). A traditional least squares analysis is shown by the points 190. Note that the most highly ranked sequence 160 identifies the true direction very well compared to the least squares analysis. The second most highly ranked sequence 170 identifies the true direction less often, and the samples are grouped consistently around a different direction cosine of about −0.6. Note that the third most highly ranked sequence 180 does not converge around any possible mode sequence.

Typically, one of the few highest ranked (highest net likelihood) mode sequences is selected. The parameters of motion (e.g., the direction to the object relative to the baseline) can then be used in follow-on steps, such as determination of the orbit of the object, if the object is a satellite.

In addition, for one sequence of observations in this sample given in Table 1, the algorithm failed to find the correct solution. In practice, this means that it would assign a probability of zero to it.

TABLE 1

| f₁ | f₂ |
|---|---|
| 0.745714568067342 | 0.33506975835189223 |
| 0.8252125091385096 | 0.3444610901642591 |
| 0.556648223195225 | 0.45859972620382905 |
| 0.3998987500090152 | 0.707469709450379 |
| 0.880965803284198 | 0.26072106161154807 |

This is a undesirable outcome because the probability of the correct sequence, even including subsequent observations, will always be zero. It is preferred to have the correct sequence identified with high probability (low negative log probability), but even if it identified with lower probability, the possibility remains that subsequent observations will bring up to a higher probability. This cannot happen once a probability of zero is assigned; because probabilities multiply, it will forever remain zero.

To diminish the possibility of a zero-probability result, the threshold can be lowered. As a result, at a threshold of 10⁻⁵, the correct sequence of modes is identified for all 1000 samples. However, in general, the ranking of the correct sequence is lower; in only about 56% of the samples is the correct sequence ranked first, and the average rank is about 3, and the lowest rank is 54. So in setting the threshold, there is a tradeoff: set high enough, and there is a very high probability the correct sequence is ranked first or second, but a small chance it is not identified at all; lowering the threshold increases the likelihood it is always identified, but lowers the average rank.

This system and method can be used with fixed antenna elements that are positioned and spaced apart to track a particular type of object or threat.

Additionally, the system and method can be used in an opportunistic manner for object tracking with any available antennas that can form baselines. For example, if two satellites with antenna are moving through space, even with a separation distance that changes, the antennas of the two spacecraft can form a baseline with a changing length, and the resulting phase differences can be analyzed to identify moving objects. In such an application, the threshold can be determined in advance for various baselines, wavelengths, and possible signal directions, or can be computed in real-time.

A system for tracking the objects in one dimension (e.g., N-S) can include two pairs of antennas with parallel baselines, preferably having different baseline lengths. The system also includes a receiver for receiving the voltage signals from the antennas and digitizing the signals for analysis, and a computer with software to receive the digitized signals and implement the method described herein. A system for tracking the objects in two dimensions (e.g., N-S and E-W), will have two additional baseline pairs perpendicular to the first pairs and associated receiver electronics. One suitable example of receiver electronics for measuring the phase is shown in S. Kawase, Radio Interferometry and Satellite Tracking, 2012, Artech House, FIG. 18.5 at page 175, incorporated herein by reference.

If both sensing from an interferometer and trajectory determination is treated probabilistically as a single problem, it is possible to obtain good results from noisy data with fewer antenna elements than is customary. An interferometer has a multimodal probability density function. When used for finding the direction of satellites, these devices are designed with antenna arrays with enough elements that that one mode dominates. The corresponding direction is used as the value when the motion of the satellite is analyzed using a least squares method, and an uncertainty computed, but that uncertainty only reflects the trajectory determination, not the measurement.

Use of Bayesian inference at each stage of the calculation results in an estimation of the multimodal probability density function, expressed as a motion estimate for each combination of modes. The technique is capable of identifying the correct trajectory and its relative probability. This will produce usable results even where the antenna array has only three elements (two baselines) and with substantial measurement, a design that would not even be contemplated with traditional analysis techniques. This offers the possibility of designing sensors that are simpler and less expensive to acquire, deploy, and maintain, that will provide as good or better information than a traditional interferometer.

The results show that can the correct answer is almost always ranked first or second. This means that the posterior PDF determined after a few observations can be compactly pruned to retain only the handful of most likely mode sequences, to be used as the prior for the next set of observations. Ultimately, a filter generalization of this technique would be the appropriate approach for sequential observations. For application of results, track correlation, propagation, and probability of collision assessment, only the top few mode combinations need be kept. While this is more complicated than if the noise follows a normal distribution, the results show that only a few modes need be kept, and each mode may be represented as if it were a single normal distribution.

Real observations will have other noise sources, and those should be modeled (including uncertainties) in order to have comparably good results with real data. The method described herein appears to be a practical method on real data, and that not only will it be possible to get better results automatically with existing sensors, but that much less expensive sensors can be deployed more broadly for equal or better orbit estimation at lower initial and ongoing cost.

Note that some of the equations used in the examples herein rely on various assumptions—independence of signal timing, Gaussian distribution of measured values of time of arrival of the signal centered on a true time, among others. It will be recognized that the method and system described herein can also be used for applications in which these assumptions are not accurate (e.g., signal timing that is not independent, distributions of arrival time measurements that are non-Gaussian).

The above specification, examples and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A radio-frequency interferometry based method for determining parameters of motion of a moving object from phase difference information from at least one radio-frequency antenna baseline, the baseline including two antennas, the method comprising:
at each of a plurality of observation events, computing a posterior probability density function from the phase differences over the antenna baseline, applying a threshold value of probability density to separate the modes, and computing a probability of each individual separated mode;
for each possible sequence of modes, determining a mode sequence probability as the product of the probabilities of each individual separated mode in that sequence;
estimating a χ² goodness of fit function based on an assumed type of motion; and
for each of the sequences of modes, determining the net probability of each possible sequence of modes as the product of a relative probability derived from the χ² and the mode sequence probability.

2. The method according to claim 1, wherein the method determines parameters of motion of the moving object from phase difference information from at least two radio-frequency antenna baselines, each of the baselines including two antennas, each baseline having a length different than the other baselines, each baseline being parallel with the other baselines, and
the posterior probability density function is a combined probability density function over each of the baselines.

3. The method according to claim 2, wherein the method for determining parameters of motion of a moving object from phase difference information is accomplished with phase information from at most two antenna baselines.

4. The method according to claim 1, further comprising:
evaluating several of the sequences of modes with the highest net probability and using the motion parameter estimates that correspond to one of the several sequences of modes with the highest net probability.

5. The method according to claim 1, wherein the parameters of motion include direction of the object relative to the radio frequency antenna baseline.

6. The method according to claim 2, wherein the computing a combined probability density function from the phase differences over each of two antenna baselines comprises solving the multimodal posterior probability function with an assumption of Gaussian distribution of measured arrival times at an observation, as
$$p ( s \vert {f}_{1} , {f}_{2} ) = \frac{\begin{matrix}{\sum }_{{n}_{1}} {\sum }_{{n}_{2}} exp [ - \frac{{( {n}_{1} - {f}_{1} - {sL}_{1} / {cT}_{sig} )}^{2}}{2 {( {σ}_{1} / {T}_{sig} )}^{2}} ] \\ exp [ - \frac{{( {n}_{2} - {f}_{2} - {sL}_{2} / {cT}_{sig} )}^{2}}{2 {( {σ}_{2} / {T}_{sig} )}^{2}} ]\end{matrix}}{\begin{matrix}\int p ( {s}^{′} ) {\sum }_{{n}_{1}} {\sum }_{{n}_{2}} exp [ - \frac{{( {n}_{1} - {f}_{1} - {s}^{′} {L}_{1} / {cT}_{sig} )}^{2}}{2 {( {σ}_{1} / {T}_{sig} )}^{2}} ] \\ exp [ - \frac{{( {n}_{2} - {f}_{2} - {s}^{′} {L}_{2} / {cT}_{sig} )}^{2}}{2 {( {σ}_{2} / {T}_{sig} )}^{2}} ] d {s}^{′}\end{matrix}}$$
wherein s is the direction cosine of the signal from the object, T_{sig} is the period of the signal, c is the velocity of the signal, n₁ is the mode associated with a first of the two antenna baselines L₁, n₂ is the mode associated with a second of the two baselines L₂, f₁ is the fraction of the signal through the cycle T_{sig} for the first baseline, and f₂ is the fraction of the signal through the cycle T_{sig} for the second baseline, and s′ is an integration variable.

7. The method according to claim 7, wherein the χ² goodness of fit factor is determined according to
$${χ}^{2} = {\sum }_{k} [ \frac{{L}_{1}}{{cT}_{sig}} {( \frac{{s}_{k 1} - {s}_{k}^{pred}}{{σ}_{f 1}} )}^{2} + \frac{{L}_{2}}{{cT}_{sig}} {( \frac{{s}_{k 2} - {s}_{k}^{pred}}{{σ}_{f 2}} )}^{2} ] ,$$
where sₖ₁ and sₖ₂ are the direction cosines solved at an observation k for the first baseline and the second baseline, respectively, sₖ^{pred} is the direction cosine predicted from the least squares fit, and σ_{f1} and σ_{f2} are phase noises for the first baseline and the second baseline, respectively.

8. The method according to claim 1, wherein the determining the net probability of each possible sequence of modes as the product of a relative probability derived from the χ² and the mode sequence probability comprises solving
$$p ( \{ {s}_{k} \} \text{\textbar} \{ {f}_{k} \} , \{ {n}_{k} \} , {σ}_{f} ) ∝ exp ( - \frac{{χ}^{2}}{2} ) \prod {p}_{k} , .$$

9. The method according to claim 1, further comprising:
setting an initial threshold by simulating motion and sampling data with a Monte Carlo method,
adjusting the threshold until known correct motion parameters occur with the highest probability weight.

10. A radio-frequency interferometer for determining parameters of motion of a moving object from measured phase differences of signals arriving at at least two antennas forming an antenna baseline, comprising:
at least one radio-frequency antenna baseline, the baseline including two antennas;
a receiver configured to measure a phase difference over the baseline;
a computer having stored instructions thereon configured for
at each of a plurality of observation events, computing a posterior probability density function from the phase differences over the antenna baseline, applying a threshold value of probability density to separate the modes, and computing a probability of each individual separated mode,
for each possible sequence of modes, determining a mode sequence probability as the product of the probabilities of each individual separated mode in that sequence,
estimating a χ² goodness of fit function based on an assumed type of motion, and
for each of the sequences of modes, determining the net probability of each possible sequence of modes as the product of a relative probability derived from the χ² and the mode sequence probability.

11. The interferometer according to claim 10, further comprising at least a second receiver and a second radio frequency antenna baseline, the second antenna baseline having a different length and the baselines being parallel, and wherein the stored instructions are configured to determine parameters of motion of the moving object from phase difference information from both baselines, and
the posterior probability density function is a combined probability density function over each of the baselines.

12. The interferometer according to claim 11, wherein the parameters of motion of the moving object are determined with phase information from at most two antenna baselines.

13. The interferometer according to claim 10, wherein the stored instructions are further configured to evaluate several sequences of modes with a highest net probability and selecting the motion parameter estimates that correspond to one of the several sequences of modes with the highest net probability.

14. The interferometer according to claim 10, wherein the parameters of motion include direction of the object relative to the radio frequency antenna baseline.

15. The interferometer according to claim 10, wherein the stored instructions are configured to compute a combined probability density function from the phase differences over each of two antenna baselines by solving the multimodal posterior probability function with an assumption of Gaussian distribution of measured arrival times at an observation, as
$$p ( s \vert {f}_{1} , {f}_{2} ) = \frac{\begin{matrix}{\sum }_{{n}_{1}} {\sum }_{{n}_{2}} exp [ - \frac{{( {n}_{1} - {f}_{1} - {sL}_{1} / {cT}_{sig} )}^{2}}{2 {( {σ}_{1} / {T}_{sig} )}^{2}} ] \\ exp [ - \frac{{( {n}_{2} - {f}_{2} - {sL}_{2} / {cT}_{sig} )}^{2}}{2 {( {σ}_{2} / {T}_{sig} )}^{2}} ]\end{matrix}}{\begin{matrix}\int p ( {s}^{′} ) {\sum }_{{n}_{1}} {\sum }_{{n}_{2}} exp [ - \frac{{( {n}_{1} - {f}_{1} - {s}^{′} {L}_{1} / {cT}_{sig} )}^{2}}{2 {( {σ}_{1} / {T}_{sig} )}^{2}} ] \\ exp [ - \frac{{( {n}_{2} - {f}_{2} - {s}^{′} {L}_{2} / {cT}_{sig} )}^{2}}{2 {( {σ}_{2} / {T}_{sig} )}^{2}} ] d {s}^{′}\end{matrix}}$$
wherein s is the direction cosine of the signal from the object, T_{sig} is the period of the signal, c is the velocity of the signal, n₁ is the mode associated with a first of the two antenna baselines L₁, n₂ is the mode associated with a second of the two baselines L₂, f₁ is the fraction of the signal through the cycle T_{sig} for the first baseline, and f₂ is the fraction of the signal through the cycle T_{sig} for the second baseline, and s′ is an integration variable.

16. The interferometer according to claim 15, wherein the χ² goodness of fit factor is determined according to
$${χ}^{2} = {\sum }_{k} [ \frac{{L}_{1}}{{cT}_{sig}} {( \frac{{s}_{k 1} - {s}_{k}^{pred}}{{σ}_{f 1}} )}^{2} + \frac{{L}_{2}}{{cT}_{sig}} {( \frac{{s}_{k 2} - {s}_{k}^{pred}}{{σ}_{f 2}} )}^{2} ] ,$$
where sₖ₁ and sₖ₂ are the direction cosines solved at an observation k for the first baseline and the second baseline, respectively, sₖ^{pred} is the direction cosine predicted from the least squares fit, and σ_{f1} and σ_{f2} are phase noises for the first baseline and the second baseline, respectively.

17. The interferometer according to claim 16, wherein the stored instructions are further configured for determining the net probability of each possible sequence of modes as the product of a relative probability derived from the χ² and determining the mode sequence probability
$$according to p ( \{ {s}_{k} \} \text{\textbar} \{ {f}_{k} \} , \{ {n}_{k} \} , {σ}_{f} ) ∝ exp ( - \frac{{χ}^{2}}{2} ) \prod {p}_{k} , .$$

18. The interferometer according to claim 10, wherein the stored instructions are further configured for setting an initial threshold by simulating motion and sampling data with a Monte Carlo method, adjusting the threshold until known correct motion parameters occur with the highest probability weight.
